(19) United States
(12) Patent Application Publication
(10) Pub. No.: US 2004/0002997 A1
(43) Pub. Date: Jan. 1, 2004

(54) Method of bundling player software and music

(75) Inventor: Bradley J. Naples, Hanover, NH (US)

Correspondence Address: HALE AND DORR, LLP, 60 STATE STREET, BOSTON, MA, 02109

(73) Assignee: MusicPlayground, Inc.

(21) Appl. No.: 10/314,765

(22) Filed: Dec. 9, 2002

Related U.S. Application Data
(63) Continuation-in-part of application No. 10/198,427, filed on Jul. 18, 2002.
(60) Provisional application No. 60/392,212, filed on Jun. 27, 2002.

(51) Int. Cl. G06F 7/00

(52) U.S. Cl. 707/104.1; 345/733

(57) ABSTRACT

A bundling method involving storing a number of performances on a storage medium, wherein each of the performances is formatted to play on a standard player application program and wherein among the plurality of performances is an enhanced performance that includes enhanced features that are not accessible using the standard player application program; and also storing on the storage medium a reference to an enhanced player application program that enables a computer to play the enhanced performance along with its enhanced features.

This application is a continuation-in-part of U.S. patent application Ser. No. 10/198,427, filed Jul. 18, 2002, which claims benefit of U.S. Provisional Patent Application No. 60/392,212, filed Jun. 27, 2002.

### TECHNICAL FIELD

The invention relates to entertainment systems, such as CD players, and the media which is played on those systems.

### BACKGROUND

The preferred format for the distribution of recorded music today is the CD-ROM. It has replaced vinyl records and cassette tapes, which were the preferred media of years past.

In the case of vinyl records, the music was stored as physical variations in the sidewall of a V-shaped groove on the record. A phonograph needle on a turntable picked up the variations in the groove sidewall as vibrations when the record revolved under the needle, In the case of cassette tapes, the music was stored as a magnetic signal on a magnetic storage medium, namely a tape. A detecting coil in a head on a tape transport sensed the stored magnetic information a head as the transport pulled the tape over the head. Today, in the case CD-ROM, the music is stored optically as digital information in the form of pits within an optical medium. By looking at reflected laser beam, the CD player detects the stored digital information and electronically converts that digital information to an analog sound signal.

Obviously, the sophistication of the equipment used to store and playback music is increasing over time as is both the density of information that can be stored and the total amount of information. The current CDs can store over 650 MB of information, which is equivalent to 12 to 20 songs, depending on the duration of the song. Typically, however, not all of the available storage media is filled with recorded music. Thus, often a considerable amount of storage space goes unused on the CDs sold in stores.

With the advent of DVDs, which have become a preferred way of storing and marketing video entertainment, disk storage capacity has increased by 7-25 times over that available on CD-ROMs. It will undoubtedly often be the case that a considerable amount of this storage real estate on the DVD will not be used since the music or video entertainment that is being sold on any particular disk does not require all of that storage space. Thus, the unused space is being used for other things such as advertising of other available songs or software.

### SUMMARY

In general, in one aspect, the invention features a bundling method that involves storing a plurality of performances on a storage medium, wherein each of the plurality of performances is formatted to play under a standard player application program and wherein among the plurality of performances is an enhanced performance that includes enhanced features that are not accessible using the standard player application program. It also involves storing on the storage medium a reference to an enhanced player application program that enables a computer to play the enhanced performance along with its enhanced features.

Other embodiments include one or more of the following features. The method also involves storing instructions on the storage medium along with the plurality of performances, the instructions indicating how to get other enhanced performances. The instructions identify a URL of a website from which the other enhanced performances are obtainable. The method also involves storing the enhanced player application program on the storage medium and it involves storing information on the storage medium which alerts a user to the existence of the enhanced player application program and the enhanced performances. The method further involves using a CD-ROM as the storage medium or using a DVD as the storage medium. The plurality of performances is recorded music. The enhanced features are either non-interactive features or interactive features or a combination of both. Among the plurality of performances are a plurality of standard performances with encoded enhancements associated therewith, the plurality of standard performances not including the enhanced performance, and wherein for each of the standard performances of the plurality of standard performances there is an associated key which enables the enhanced player application to play that standard performance and its associated encoded enhancements.

In general, in another aspect, the invention features a storage medium having stored thereon a plurality of performances each of which is formatted to play under a standard player application program running on a computer and wherein among the plurality of performances is an enhanced performance that includes enhanced features that are not accessible using the standard player application program; and a reference to an enhanced player application program that enables the computer to play the enhanced performance along with its enhanced features.

Other embodiments include one of more of the following features. The storage medium also has stored thereon the enhanced player application program as well as instructions indicating how to get other enhanced musical performances. The storage medium also has stored thereon information which alerts a user to the existence of the enhanced player application program and the enhanced performances. Among the plurality of performances there is a plurality of standard performances with encoded enhancements associated therewith, the plurality of standard performances not including the enhanced performance, and wherein for each of the standard performances of the plurality of standard performances there is an associated key which enables the enhanced player application program to play that standard performance and its associated encoded enhancements.

In general, in yet another aspect, the invention features a bundling method involving storing a plurality of objects on a storage medium, wherein each of the plurality of objects is formatted to run under a standard application program and wherein among the plurality of objects is an enhanced object that includes enhanced features that are not accessible using the standard application program; and storing on the storage medium a reference to an enhanced application program that enables a computer to run the enhanced object along with its enhanced features.

In general, in still yet another aspect, the invention features a storage medium having stored thereon a plurality of objects each of which is formatted to run under a standard application program running on a computer and wherein among the plurality of objects is an enhanced object that includes enhanced features that are not accessible using the standard application program; and a reference to an enhanced application program that enables the computer to run the enhanced object along with its enhanced features.

In other embodiments, the objects are music performances, the standard application program is a standard music player program that is capable of playing the music performances, and the enhanced application program is an enhanced music player program.

In general, in still yet a further aspect, the invention features a method of distributing music involving dstributing to customers a plurality of storage media each of which includes a plurality of music performances and an enhanced player application program stored thereon, wherein each of the plurality of music performances is formatted to play using a standard player application program, wherein among the plurality of music performances is an enhanced music performance that includes enhanced features that are not accessible using the standard player application program, and wherein the enhanced application program enables a computer to play the enhanced music performance along with its enhanced features; and in response to further purchases from customers who have bought said plurality of storage media, enabling those purchasing customers to access enhanced versions of the plurality of performances that are playable using the enhanced application program.

The available unused storage area on CDs provides an inexpensive and potentially very effective opportunity to market other software entertainment products in a much more targeted and effective manner, focusing on that segment of the population that is most likely to be interested. In essence, a few enhanced songs can be used to showcase the capabilities of the special player software and entice the user to visit a commercial website from which the he or she can purchase other enhanced music by the same and other artists. This also provides a very good mechanism for marketing new entertainment software as well. By this mechanism, a traditional music distribution operation can leverage itself into the entertainment software market.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a CD-ROM disk on which there is stored music tracks for a number of different performances and files for both non-interactive and interactive enhancements to one or more of the music tracks; and

FIG. 2 shows representative components of a system that supports the various features associated with the CD-ROM of FIG. 1.

Like reference symbols in the various drawings indicate like elements.

### DETAILED DESCRIPTION

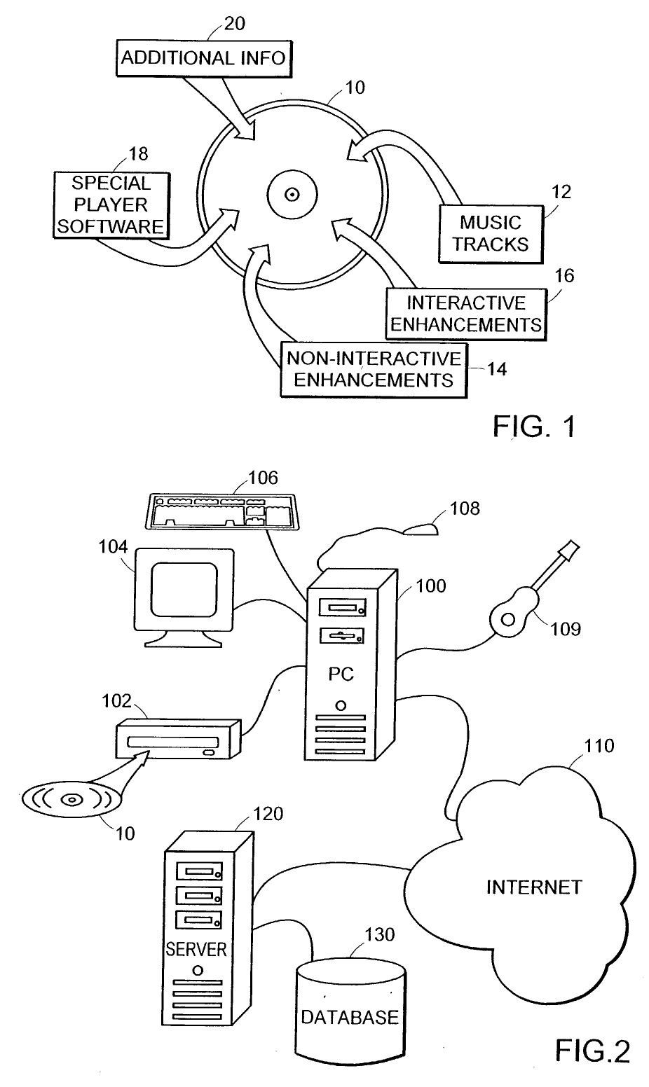

Referring to FIG. 1, a described embodiment is a CD-ROM disk 10 on which there are a number of music tracks 12 storing different songs or musical performances. All of the songs are presented in a standard CD music format that can be played using a conventional player or CD player equipment that many consumers own. In addition, for a few selected songs, the disk contains non-interactive enhancements 14 and interactive enhancements 16, examples of which are provided below. These enhancements are not accessible by a conventional CD player. That is, the conventional player does not recognize their presence and will not “play” them. To access or play the enhancements, the user must have special player software. In the described embodiment, that special player software 18 is also provided on the disk and can be loaded into the user's computer. Also, stored on the disk is other information 20 relating to the special player software and the enhancements, the details of which will be provided in the following description.

We note that FIG. 1 is a diagrammatic representation of the categories of material and/or information that is stored on the CD-ROM. The form in which it is illustrated is not meant to imply anything about how it is stored on the disk. Those details are dictated by the various formats that have been promulgated by industry for CD-ROMs and other storage media and of course might also depend on the operating systems that are being used in the computers.

Examples of the types of enhancements that might be included along with a “normally” recorded song are described in U.S. Pat. No. 5,393,926, which is incorporated herein by reference. In brief, the system that is described therein includes a CD-ROM disc on which is stored an interleaved and synchronized music track, video track, and audio file. The music track is a recorded performance such as one might buy commercially on a CD-ROM. Or it could be a performance recorded specially for this type of presentation which is combined with other non-interactive and interactive enhancements. The video track stores visuals that accompany the performance. The visuals could be, for example, of the artist performing the music or they could by other visual accompaniments designed to enhance the user's experience when playing the music. The audio file represents the interactive part of the performance, which might be a guitar track storing the music that a user can “play.” If the audio file represents a guitar track, the music track instead of being a complete recorded performance could omit the guitar track that the user will add.

In the system described by the patent, music from the separate guitar track is generated in response to input from the user and only to the extent that such input is provided. The input is in the form of activation signals that are generated by an active pick that includes an internal vibration sensitive switch. When the user strums the pick across guitar strings or any rough surface, the vibration sensitive switch generates activation signals. The player software maps those activation signals to the musical sounds (i.e., guitar sounds) stored in the audio file. If no activation signal occurs within some time period surrounding a given note or musical sound, then the system does not generate that guitar sound. The activation signals that are produced are mapped in sequence to the stored guitar sounds that fall within a time period bracketing the time at which that guitar sound is supposed to be played.

It should be apparent from this description, that the particular system described in the above-referenced patent gives a user some flexibility in determining when the sounds are played and conversely imposes on the user a minimal required skill level to produce the “right” overall sound.

Systems similar to that which is described above are commercially available from MusicPlayground, Inc. which is located in Massachusetts. Another example of a more sophisticated player that enables more enhancements to recorded music is described in U.S. patent application Ser. No. 10/118,862, filed Apr. 9, 2002, entitled “Method And Apparatus For Storing A Multipart Audio Performance With Interactive Playback,” and incorporated herein by reference.

The information that is stored within additional information 20 on the CD-ROM includes a reference to the special player software and its location, a URL link or reference to a website through which the consumer can obtain other enhanced musical performances by that artist as well as by other artists, and possibly a URL link or reference to a website through which the consumer can obtain a more featured version of the special software. In other words, in addition to using the CD-ROM as vehicle for marketing additional enhanced performances, one could also use the CD-ROM as a vehicle for marketing the special player software. In the latter case, the version of the special software that is provide to the user free of charge might be a trimmed down version with only sufficient features to enable the consumer to experience the enhancements of the few songs that are provide with those enhancements. To obtain a more advanced version of the player software, information stored on the CD-ROM directs the consumer to a source from which such software can be purchased or licensed. Also included within additional information 20 is a presentation which runs automatically when the disk is put in the CD-ROM drive of a computer. The presentation, through visuals displayed on the computer screen, informs the user of the presence of the special player software, the existence of samples of enhanced music that are on the CD-ROM that was purchased, and whatever else seems appropriate to effectively market the products and to enable a user to use them.

FIG. 2 shows a representative system 100 that supports the various features that are stored on or accessible through a CD-ROM. At the user's location, there is a PC 100 with an attached CD-ROM drive 102. PC 100 includes some loaded version of CD player software that enables the user to play the music stored on the disk but that is not capable of accessing or playing the enhancements. There are many options for such player software available among freeware, shareware, and commercially available products. Examples of some commonly used player software include Audiostation, RealOne Player, and Sound Stream, just to name a few.

The PC also includes other components that are commonly found on or with PC including a display 104, a keyboard 106, and a mouse 108. In addition, there is a interface (not shown) for connecting to the Internet 110. This might be an internal modem or a cable card. If the enhancements that are to be played are interactive, there might also be a “guitar” activation device such as is described in the above-mentioned U.S. Pat. No. 5,393,926 and U.S. patent application Ser. No. 10/118,862. Though this is represented as “guitar” it could be any appropriate device which allows user input to provide the interactive part.

Remotely from PC 100 but accessible through the Internet at a URL identified on the CD, there is a server 120 and an associated database 130. Typically, database 130, which might be in one location or distributed across many locations, stores enhanced songs and performances by many different artists and groups. Server 120 implements an interface through which the user can purchase or license those other songs.

Server 120 might also store the more advanced version of the special player software that the consumer can purchase or license.

When the disk is inserted into CD-ROM drive connected to a PC computer, the computer executes a program on the CD-ROM which notifies the user of the features and products that are available on the CD. That is, the program automatically alerts the user to what is on the disk and advertises its capabilities, thus inviting the user to try them. The user can decide to play the stored songs as he or she would do for any of the commercially available songs and this would be done by using the conventional player software that has been loaded into or comes with the computer. Or the user can elect to load the special player software into computer memory. The computer then becomes capable of playing or displaying the enhanced features associated with a select few songs on the disk. If the special player software is stored on the same CD that holds the music, loading is a simple matter. If the software is located at a remote server, the CD will provide the URL to that location and the user establishes a connection to the identified website and downloads the special player software.

Once downloaded, the user can use it to play any of the songs including the enhanced songs. When the enhanced songs are played, the computer plays the enhancements along with the underlying song.

If the user likes the particular types of enhancements that are provided with the enhanced songs, the user can go to the website identified by another URL stored on the CD and purchase or license more music of that type.

We have provided particular examples of enhancements that might be associated with standard recorded music. Those examples, however, are not meant to be limiting. The underlying material could be any kind of audio and/or visual recorded or stored material that is or might be played on conventional players. Whereas, the enhancement could be any kind of non-interactive and/or interactive material that requires a different player to play the underlying material with the associated enhancements.

Though we have described bundling both non-interactive and interactive enhancements along with the music, it might be more appropriate to store only one or the other, depending on other considerations such as the entertainment that is being enhanced and the commercial requirements and/or objectives.

Also, instead of providing the complete special player software on the disk, a limited feature version could be provided along with a link or other information directing the user to a location from which he or she can obtain the compete version. Indeed, rather than storing the special software on the disk, there could instead be a reference or link to an off-disk location from which it can be downloaded.

The bundling that was described was implemented on a CD-ROM storage medium. But it could just as easily have been implemented on other storage media such as other types of CD, DVD, or even smartcards, just to name a few. In addition, the bundled material could simply be a transmitted file that includes the various components or it could be a number of transmitted, linked files or components, which collectively represent the bundled entity. In all of these alternative forms, one common feature is that there is a collection of un-enhanced and enhanced songs along with a reference to (or a copy of) the special player software that is necessary to play the enhanced songs.

There are alternative ways to make the enhanced performances available to users other than those described above. For example, one alternative is to include on the CD enhanced versions of all of the performances or songs that are on the CD. To prevent the user from being able to access the enhanced features of most of the songs, the enhancements for most of the songs are encrypted or “locked” using well-known digital encryption technology. So, without the required decryption key, the user cannot play the enhancements on those songs. The remaining stored songs, which also include enhancements, are not in any way encrypted or “locked” so the user can play them on the special software to experience the enhancements. The keys could operate by enabling the special player to read or access the enhanced features of the locked songs.

It is also possible to include the full-featured special player on the CD but lock out some features (by again using encryption techniques) so that the user only has access to the standard, trimmed down version of the special player (e.g. the “lite” version).

As before, a user who purchases the CD will be able to discover and experience a few of the enhanced performances that are stored on the CD by simply playing those songs on the “lite version” of the special player software that is also provided on the CD. If the user enjoys the enhanced versions, by visiting a website that is identified on the CD, he can purchase and download the keys needed to unlock the enhancements of other songs on the CD. Optionally, he can also purchase the key(s) needed to unlock the extended features of the full-featured special player software. With those purchased keys, the user can then access further enhanced performances on the CD and can experience all of the features of the special player software.

One advantage of using keys to unlock functionality that is stored on the CD is that it becomes easier for consumers to purchase the enhanced performances (no time consuming downloads of large amounts of song data are required). Another advantage is that it would be easier to prevent the sharing of enhanced songs among users who do not want to pay for enhanced performances.

The above-described techniques can be combined in a variety of ways to provide the desired functionality to the consumer.

A number of embodiments of the invention have been described. Nevertheless, it will be understood that various further modifications beyond those described above may be made without departing from the spirit and scope of the invention. Accordingly, other embodiments are within the scope of the following claims.

What is claimed is:

1. A bundling method comprising:
storing a plurality of performances on a storage medium, wherein each of said plurality of performances is formatted to play under a standard player application program and wherein among the plurality of performances is an enhanced performance that includes enhanced features that are not accessible using the standard player application program; and
storing on said storage medium a reference to an enhanced player application program, said enhanced player application program that enables a computer to play said enhanced performance along with its enhanced features.

2. The method of claim 1 further comprising storing instructions on the storage medium along with the plurality of performances, said instructions indicating how to get other enhanced performances.

3. The method of claim 2 wherein the instructions identify a URL of a website from which said other enhanced performances are obtainable.

4. The method of claim 1 further comprising storing the enhanced player application program on the storage medium.

5. The method of claim 1 further comprising storing information on the storage medium which alerts a user to the existence of the enhanced player application program and the enhanced performances.

6. The method of claim 1 further comprising using a CD-ROM as the storage medium.

7. The method of claim 1 further comprising using a DVD as the storage medium.

8. The method of claim 1 wherein the plurality of performances is recorded music.

9. The method of claim 1 wherein the enhanced features are non-interactive features.

10. The method of claim 1 wherein the enhanced features are interactive features.

11. The method of claim 1 wherein among the plurality of performances are a plurality of standard performances with encoded enhancements associated therewith, said plurality of standard performances not including said enhanced performance, and wherein for each of the standard performances of said plurality of standard performances there is an associated key which enables the enhanced player application to play that standard performance and its associated encoded enhancements.

12. A storage medium having stored thereon:
a plurality of performances each of which is formatted to play under a standard player application program running on a computer and wherein among the plurality of performances is an enhanced performance that includes enhanced features that are not accessible using the standard player application program; and
a reference to an enhanced player application program that enables the computer to play said enhanced performance along with its enhanced features.

13. The storage medium of claim 12 also having stored thereon said enhanced player application program.

14. The storage medium of claim 12 also having stored thereon instructions indicating how to get other enhanced musical performances.

15. The storage medium of claim 12 also having stored thereon information which alerts a user to the existence of the enhanced player application program and the enhanced performances.

16. The storage medium of claim 12 wherein among said plurality of performances there is a plurality of standard performances with encoded enhancements associated therewith, said plurality of standard performances not including said enhanced performance, and wherein for each of the standard performances of said plurality of standard performances there is an associated key which enables the enhanced player application program to play that standard performance and its associated encoded enhancements.

17. A bundling method comprising:
storing a plurality of objects on a storage medium, wherein each of said plurality of objects is formatted to run under a standard application program and wherein among the plurality of objects is an enhanced object that includes enhanced features that are not accessible using the standard application program; and
storing on said storage medium a reference to an enhanced application program, said enhanced application program enabling a computer to run said enhanced object along with its enhanced features.

18. The method of claim 17 wherein the objects of said plurality of objects are music performances, wherein the standard application program is a standard music player program that is capable of playing the music performances, and wherein the enhanced application program is an enhanced music player program.

19. A storage medium having stored thereon:
a plurality of objects each of which is formatted to run under a standard application program running on a computer and wherein among the plurality of objects is an enhanced object that includes enhanced features that are not accessible using the standard application program; and
a reference to an enhanced application program that enables the computer to run said enhanced object along with its enhanced features.

20. The storage medium of claim 19 wherein the objects of said plurality of objects are music performances, wherein the standard application program is a standard music player program that is capable of playing the music performances, and wherein the enhanced application program is an enhanced music player program.

21. A method of distributing music comprising:
distributing to customers a plurality of storage media each of which includes a plurality of music performances and an enhanced player application program stored thereon, wherein each of said plurality of music performances is formatted to play using a standard player application program, wherein among the plurality of music performances is an enhanced music performance that includes enhanced features that are not accessible using the standard player application program, and wherein said enhanced application program enables a computer to play said enhanced music performance along with its enhanced features; and
in response to further purchases from customers who have bought said plurality of storage media, enabling the purchasing customers to access enhanced versions of said plurality of performances that are playable using the enhanced application program.
